(19) United States
(12) Patent Application Publication
(10) Pub. No.: US 2024/0412048 A1
(43) Pub. Date: Dec. 12, 2024

(54) GENERATIVE ARTIFICIAL INTELLIGENCE THAT DYNAMICALLY SUMMARIZES TEXT INCLUDING SUPPORT TICKETS

(71) Applicant: SupportLogic, Inc., San Jose, CA (US)

(72) Inventors: Ryan C. Knudson, San Jose, CA (US); Anubhav Saggi, San Jose, CA (US); Aditya Murthi, San Jose, CA (US)

(73) Assignee: SupportLogic, Inc., San Jose, CA (US)

(21) Appl. No.: 18/736,923

(22) Filed: Jun. 7, 2024

Related U.S. Application Data
(60) Provisional application No. 63/471,857, filed on Jun. 8, 2023.
(60) Provisional application No. 63/471,898, filed on Jun. 8, 2023.

(51) Int. Cl. G06N 3/0475; G06F 40/166; G06F 40/40; G06Q 10/10

(52) U.S. Cl. CPC G06N 3/0475; G06F 40/166; G06F 40/40; G06Q 10/10

(57) ABSTRACT

A system fine-tunes at least one generative artificial intelligence model to summarize at least text from a historical support ticket. The system receives a request from a user interface to generate a summary of at least text from a support ticket assigned to a support agent to assist a customer. At least one generative artificial intelligence model generates a summary of the at least text from the support ticket assigned to the support agent to assist the customer, wherein the summary comprises an overview of the at least the text from the support ticket and which includes some text that is absent from the at least the text from the support ticket. The system outputs the summary to the user interface, wherein the summary enables a user to efficiently understand the at least the text from the support ticket.

### CROSS REFERENCE TO RELATED APPLICATION

This application claims priority under 35 U.S.C. § 119 or the Paris Convention from U.S. Provisional Patent Application 63/471,857, filed Jun. 8, 2023, and U.S. Provisional Patent Application 63/471,898, filed Jun. 8, 2023, the entire contents of which are incorporated herein by reference as if set forth in full herein.

### BACKGROUND

A ticketing system (such as provided by Jira, GitHub, ServiceNow, Salesforce, Zendesk, or Freshdesk) generates tickets, which may be referred to as support tickets, service tickets, or cases, which track the communications between individuals, users, groups, teams, organizations, and businesses in spaces such as support, user service, sales, engineering and information technology. Although many of the following examples are described in the context of a ticketing system for a support space, embodiments of this disclosure apply equally to other ticketing systems for other spaces. In a support space example, a customer of a software product experiences a problem using the software product, activates a ticketing system, and submits a support ticket to the support organization which provides support for the software product.

The support organization employs support agents who can receive the support ticket and respond to the customer, which maintains strong accountability standards and commands customer loyalty. Robust technical support for software products underlies a strong, sustained, and successful partnership between support organizations and their customers. In an ideal situation, a support agent accurately identifies, troubleshoots, and resolves a customer's problem in a timely manner, and closes the support ticket.

Support organizations that have many customers typically have difficulty prioritizing their relationships with their customers or invest heavily into closely evaluating those relationships. Since software products are often intricately tied with customer workflows and operations, stabilizing this degree of customer dependence on a long-term basis requires a support organization to evolve and adapt to the customers' emerging and growing problems. If handled incorrectly, customer needs, such as those expressed in support tickets, can remain unresolved for long periods of time and result in dissatisfied customers, with outcomes ranging from poor customer satisfaction scores to disengagement and churn.

### BRIEF DESCRIPTION OF THE DRAWINGS

FIG. 1 illustrates a block diagram of example data structures for generative artificial intelligence that dynamically summarizes text including support tickets, under an embodiment;

FIG. 2 illustrates a block diagram of additional example data structures for generative artificial intelligence that dynamically summarizes text including support tickets, under an embodiment;

FIG. 3 illustrates a block diagram of an example system for generative artificial intelligence that dynamically summarizes text including support tickets, under an embodiment;

FIG. 4 illustrates a block diagram of an example artificial intelligence platform for generative artificial intelligence that dynamically summarizes text including support tickets, under an embodiment

FIG. 5 is a flowchart that illustrates a computer-implemented method for generative artificial intelligence that dynamically summarizes text including support tickets, under an embodiment; and

FIG. 6 is a block diagram illustrating an example hardware device in which the subject matter may be implemented.

### DETAILED DESCRIPTION

In order to assess the performance of teams of support agents, support organizations may want to summarize customer accounts, including metrics that help measure the performances of their teams and agents while also providing a measure of the overall customer experience. Such metrics show performance of teams and agents in terms of efficiency, speed of resolution and workload while also helping to identify gaps in the support process and opportunities for growth. Hence these account summaries could also serve as an indirect indicator of the progress that has been made towards achieving a support organization's business goals, such as customer retention and expansion. Therefore, account summaries generated by aggregating key customer support metrics derived using data from multiple sources could help provide a holistic understanding of a support organization's performance across their customer base. Such learnings could then help with the creation of processes and strategies to elevate the performances of support teams as well. The automated summation of such account summaries has been beyond the scope of contemporary artificial intelligence.

Advances in the field of artificial intelligence accompanied by corresponding improvements in large-scale computation have led to a new era in artificial intelligence technology, namely generative artificial intelligence, which is a type of artificial intelligence that may be used to generate content such as text, images, videos, or code. The wide-scale adoption of this technology has been made possible by simple user-interfaces that may be used to create high-quality text, videos and graphics.

Two other recent advances that have led to generative artificial intelligence going mainstream are the development of transformers that have led to the advent of large language models. Traditionally, most machine/deep learning models used for tasks such as content generation have required more human input such as feature engineering and parameter tuning, as well as curated and pre-processed data, but not human intervention in the form of contextual rules that place constraints on what can and cannot be generated given input data. However, transformers are a class of machine learning models that enable training on data without requiring much human intervention since they are able to discern and “remember” context across an entire dataset. Depending heavily on the data, such models can therefore be trained on large volumes of data, potentially resulting in generated content that has more depth and is hence more meaningful.

Input to generative artificial intelligence models is available via a prompt that may be in the form of text, an image, a video, a design, musical notes, or any input that the artificial intelligence system can process. Various artificial intelligence algorithms then return new content in response to the prompt. Early offerings of such models have not been without issues though, especially with regard to accuracy and bias, as well as being prone to responding to input by generating highly unusual content. Nevertheless, while still in the early stages of model evaluation and refinement, the initial results are very promising and therefore indicative of the potential of this technology to be a significant development for businesses.

Embodiments of the present disclosure apply generative artificial intelligence to text summarization. Text summarization approaches to date have been both rule-based, statistical and hybrid, often employing neural networks, graph-based approaches, and both bottom-up and top-down approaches. Much of the work done to date in text summarization has been best suited to language that adheres to grammatical standards for a particular language, what may be called newspaper language. State-of-the-art methods employed in text summarization fall into two categories: extractive summarization, which selects and extracts units, usually sentences, for summary inclusion from the documents to be summarized; and abstractive summarization, which generates a summary much like a human would, by understanding the collection of documents and authoring a summary that includes some text that is not necessarily taken directly from any one document.

Current state-of-the-art methods employ Recurrent Neural Networks, Bidirectional Encoder Representations from Transformers (BERT), or combinations and variants of the same. The evaluation of state-of-the-art text summarization models is comprised of text and summary pairs from data such as newspapers, news reports, and Reddit. These datasets are used to evaluate text summarization methods in a supervised fashion. It is important to note here that the datasets used to evaluate and train these state-of-the-art models are not all newspaper language, and that some of the data is more conversational or casual than typical newspaper language.

Embodiments provide generative artificial intelligence that dynamically summarizes text including support tickets. A system fine-tunes at least one generative artificial intelligence model to summarize at least text from a historical support ticket. The system receives a request from a user interface to generate a summary of at least text from a support ticket assigned to a support agent to assist a customer. At least one generative artificial intelligence model generates a summary of the at least text from the support ticket assigned to the support agent to assist the customer, wherein the summary comprises an overview of the at least the text from the support ticket which includes some text that is absent from the at least the text from the support ticket. The system outputs the summary to the user interface, wherein the summary enables a user to efficiently understand the at least the text from the support ticket.

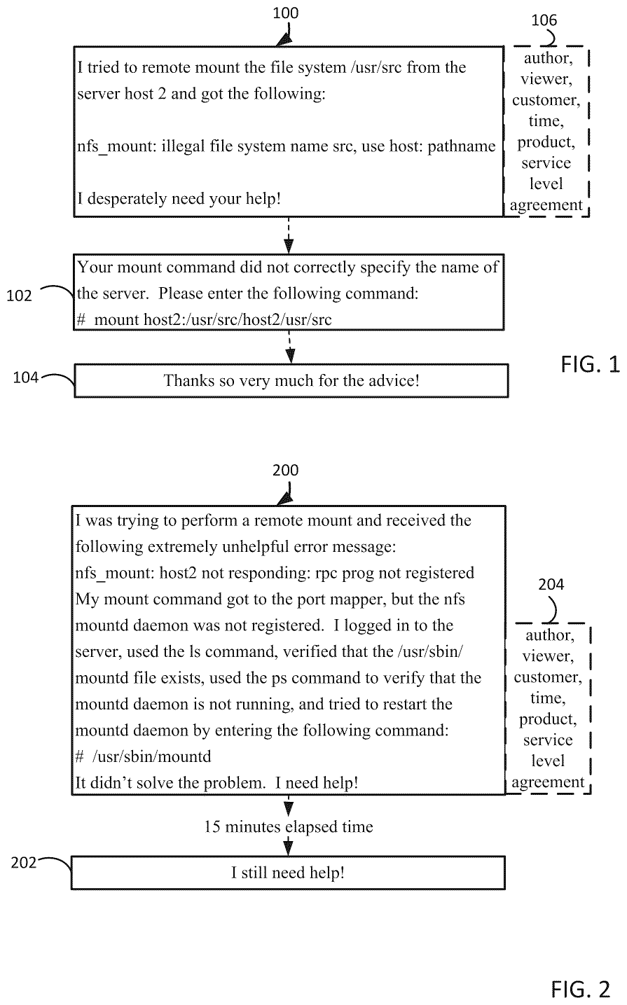

For example, a system has a server that receives a set of closed customer support tickets, which includes the support ticket 100 that contains subsequent communications 102 and 104 between a support agent and a customer, and the support ticket's metadata 106, as depicted by FIG. 1. Then the server's generative artificial intelligence models were fine-tuned to summarize the text of the closed customer support tickets, including an overview which described the support ticket 100 as listing a “simple” remote mount problem with an “easy” solution, even though the words “simple” and “easy” were not in the support ticket 100, the subsequent communications 102 and 104, or the support ticket's metadata 106. After the server receives support tickets, which include the support ticket 200 that contains the subsequent communication 202 and the support ticket's metadata 204, as depicted by FIG. 2, the server receives a request from Sam, a system administrator to generate a summary of a customer account for Acme Corporation, which includes the support ticket 200. Then the server's pre-trained generative artificial intelligence models summarize the text of Acme Corp.'s support tickets, including an overview which described the support ticket 200 as a “difficult” remote mount problem with a “complex” solution, even though the words “difficult” and “complex” are not in the support ticket 200, the subsequent communication 202, or the support ticket's metadata 204. The server outputs the summary of the Acme customer account to Sam the system administrator, who can efficiently understand the overview of Acme's support tickets, including the summary of the support ticket 200, that has a “difficult” remote mount problem with a “complex” solution.

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Although these embodiments are described in sufficient detail to enable one skilled in the art to practice the disclosed embodiments, it is understood that these examples are not limiting, such that other embodiments may be used, and changes may be made without departing from their spirit and scope. For example, the operations of methods shown and described herein are not necessarily performed in the order indicated and may be performed in parallel. It should also be understood that the methods may include more or fewer operations than are indicated. In some embodiments, operations described herein as separate operations may be combined. Conversely, what may be described herein as a single operation may be implemented in multiple operations.

Reference in the specification to “one embodiment” or “an embodiment” or “some embodiments,” means that a particular feature, structure, or characteristic described in conjunction with the embodiment may be included in at least one embodiment of the disclosure. The appearances of the phrase “an embodiment” or “the embodiment” in various places in the specification do not necessarily all refer to the same embodiment.

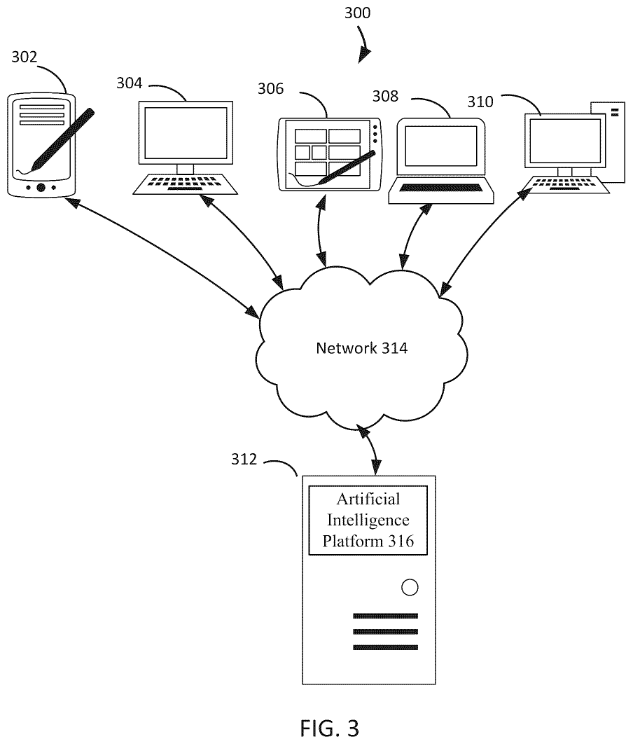

FIG. 3 illustrates a block diagram of an example system 300 for generative artificial intelligence that dynamically summarizes text including support tickets, under an embodiment. As shown in FIG. 3, the system 300 may illustrate a cloud computing environment in which data, applications, services, and other resources are stored and delivered through shared data centers and appear as a single point of access for customers. The system 300 may also represent any other type of distributed computer network environment in which servers control the storage and distribution of resources and services for different client users.

In an embodiment, the system 300 represents a cloud computing system that includes a first client 302, a second client 304, a third client 306, a fourth client 308, a fifth client 310; and a server 312 that may be provided by a hosting company. The clients 302-310 and the server 312 communicate via network 314. The server 312 includes an artificial intelligence platform 316.

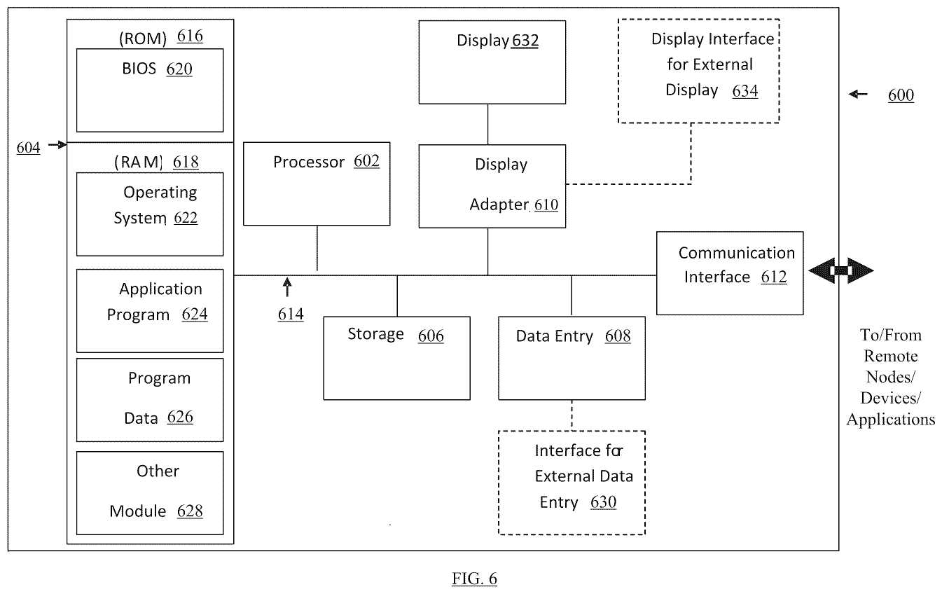

Even though FIG. 3 depicts the first client 302 as a smartphone 302, the second client 304 as a terminal 304, the third client 306 as a tablet computer 306, the fourth client 308 as a laptop computer 308, and the fifth client 310 as a personal computer 310, each of the system components 302-312 may be any type of computer system. The system elements 302-312 may each be substantially similar to the hardware device 600 depicted in FIG. 6 and described below. FIG. 3 depicts the system 300 with five clients 302-310, one server 312, one network 314, and one artificial intelligence platform 316. However, the system 300 may include any number of clients 302-310, any number of servers 312-, any number of networks 314, and any number of artificial intelligence platform 316.

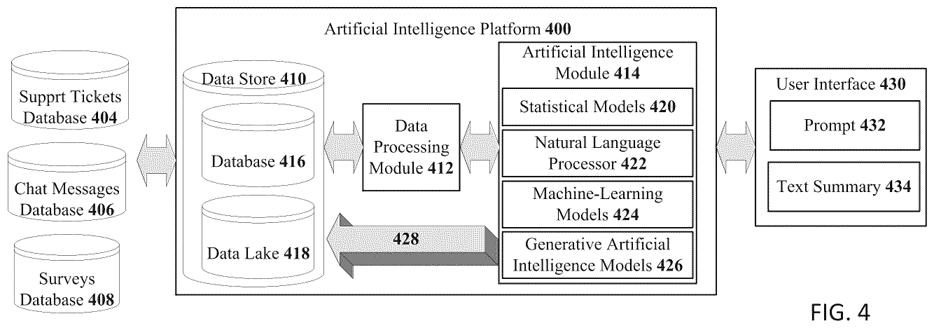

A support organization's artificial intelligence platform 316, which may also be referred to as the artificial intelligence framework 316 or an artificial intelligence platform 400, as shown in FIG. 4. The platform 400 consists of several components, the first of which is a data layer 402 which comprises functionality, a support ticket database 404, a chat messages database 406, and a survey database 408, and/or application programming interfaces (APIs), which store and/or pulls in data from multiple sources that is then processed to enable consumption by the artificial intelligence platform 400. The core artificial intelligence platform 400 consists of three primary components, a data store 410, a data processing model 412, and an artificial intelligence module 414.

The data store 410 may consist of one or more database 416, which may be PostgreSQL database instances 416, which currently hold support ticket data ingested by the artificial intelligence platform 400 from multiple clients. The data store 410 can also contain a data lake 418, which may be a Snowflake data lake 418 that includes some processed feature data from the database(s) 416. The data processing module 412 layer currently processes volumes of support ticket data from the database(s) 416, and runs this data to the artificial intelligence module 414. However, this utility is also set up to process other types of data (such as chat and voice) that are transformed into a form that is consumed by the artificial intelligence module 414. The artificial intelligence module 414 consists of different types of artificial intelligence models 420-426 that ingest processed data from the data processing module 412 and make predictions that the data processing module 412 sends back 428 to the data store 410 for storage with the processed data facets that may be used to drive business decisions for a support organization, and for further consumption by other components in the support organization's software stack.

The artificial intelligence models 420-426 in the artificial intelligence module 414 include statistical models 420, a natural language processor 422, machine-learning models 424, and generative artificial intelligence models 426, which are used for multiple tasks, such as language translation, and intelligent support ticket routing, as well as support ticket and account summarization. The predictions stemming from the artificial intelligence module 414 are surfaced in a user interface 430 and may be subsequently utilized by a support organization to make decisions and drive value for their customers. The support organizations' artificial intelligence platform 400 can ingest volumes of support ticket data that are processed and sent to the various models 420-426 within the artificial intelligence module 414 to produce a variety of support ticket level predictions. Some of these predictions include things like the likelihood of a support ticket escalating, extracted support ticket sentiment, and automatic assignment of incoming support tickets to support agents for issue resolution.

The data processing module 412 also produces account level features such as the account health score metric that can provide a summary of the health of a customer's account at any point in time. Therefore, in order to produce account summaries, some of the aforementioned data may be reused. At its core, the workflow to produce account summaries consists of utilizing the data processing module 412 to pull in some of the derived support ticket and account level data from the data store 410 and give this information to the generative artificial intelligence models 426 in the artificial intelligence module 414 that produce intelligent summaries of a customer's support tickets and the customer's account at any given time.

The generative artificial intelligence models 426 are pre-trained, and can be fine-tuned for the current objective to generate the summaries. In order to take advantage of the volumes of data that generative artificial intelligence models 426 have been trained on, the fine-tuning task involves sending in support ticket/or customer account level data from multiple sources, such as chat and voice, not just processed support ticket data that already sits in a support organization's ecosystem to generate intelligent and accurate summaries for a given set of support tickets and/or account(s). A system user or administrator essentially enters text at a prompt 432 on the user interface 430 regarding a customer's support tickets, the customer's account, or multiple customers' accounts they want to summarize and the artificial intelligence platform 400 would then parse and supply the processed text to the pre-trained generative artificial intelligence models 426 that have been fine-tuned for the current objective which would then generate the summary and send the requested text summary 434 back to the user interface 430.

Text summarization may be defined as the condensing of one or more documents sharing a similar theme into an overview or conclusion which produces new knowledge. Documents may be items, both textual and audio, such as questions or messages consisting of media such as a support ticket comment, a support ticket note, a frequently asked question (FAQ) entry, an email, a chat message, or a knowledge-based article. Whether by use of extractive or abstractive summarization methods, dynamic summarization can include various types of summarization that may be needs-based, or summarization for a particular audience, such as a support manager. A summarization may include all or only part of any support ticket, such as temporal or content-based selections. Examples of a dynamic summarization include summarization based on a particular support agent's involvement, a time-based summarization, such as up to point X in time, or after such an event occurring, such as escalation.

Given these nonexclusive elements of dynamic summarization, the integrations and attributes of dynamic summarization may be based on the five main categories of support ticket or account-holistic features, support ticket or account-specific features, any and all communications relating to a support ticket or account, support ticket or account descriptive statistics, and support ticket or account machine-learning derived metrics. Support ticket or account-holistic features include support ticket or account status or priority. Support ticket or account-specific features include support ticket or account contact or support ticket account. All communications related to a support ticket or account include inbound and outbound messages, internal or external comments, emails, voice recordings or transcriptions, screen-recording videos or transcripts, smart-reminder content, or external sources of content such message boards or frequently asked questions related to the support ticket or account.

Descriptive statistics can include comment-type ratio (inbound vs inbound), support ticket recency, mean-time to respond for both support agents and customers, machine-learning elements such as signals or sentiment(s) related to a support ticket, such as frustration, escalation request, call request, or urgency. Machine-learning metrics derived from the preceding signals or sentiments include likelihood to escalate, needs attention, or churn risk.

The methodology for scoring or ranking attributes, such as support ticket features and descriptive statistics, for generating summaries may include prioritization based upon time, or prioritization based upon customer (or other entity) determined items of importance. The prioritization may also be based upon solutions or potential solutions, including speed and case of the solutions or potential solutions.

Therefore, text summaries may be generated by aggregating key customer support metrics derived using data from multiple sources to help provide a holistic understanding of a support organization's performance across their customer base, which generates a support organization summary. Such learnings can then help with creation of processes and strategies to elevate the performance of a support organization as a whole.

Data and artificial intelligence technology may be utilized to produce customer account summaries on behalf of the customers of a support organization. The various types of data available within and outside a support organization's ecosystem may be used to generate the support ticket and customer account summaries. The artificial intelligence platform 400 processes data to generate various derived metrics that are aggregated and sent to the generative artificial intelligence models 426 to produce support ticket and customer account summaries. Customer support metrics may be derived from multiple data sources such as support tickets, chat transcripts, voice and customer satisfaction surveys.

Therefore, these metrics may be divided into multiple categories depending on the type and source of the data. For example, metrics that are derived directly from support ticket level data include priority level/severity of a support ticket, first response time of a support agent, total number of support agents assigned to a support ticket, a support ticket's age, and a support ticket resolution rate/mean time to resolution. Some other metrics, such as customer satisfaction score (CSAT), net promoter score (NPS) and customer effort score, which are targeted towards gauging the overall experience of the customer, may be derived from customer survey data. A comprehensive picture of the efficacy of support teams, at any point in time, is therefore provided by intelligently summarizing these metrics for each (and across) customer account(s).

The support organizations' artificial intelligence platform 400 ingests volumes of support ticket data from multiple customers and therefore already contains most of the aforementioned support ticket level metrics, and can also extract proprietary customer experience metrics, such as the sentiment and needs attention scores, directly from the text in the support ticket data. At the customer account level, a support organization can also compute the account health score metric that provides a measure of the overall health of an account based on several support ticket level features. These “internally derived” metrics along with those metrics available from other data sources may be further processed and fed to the generative artificial intelligence models 426 to summarize a customer's support tickets and the customer's account at any given instant of time. A support organization can feed all the described data into the artificial intelligence platform 400 to provide the support organization with a comprehensive summary of their customer accounts.

Uses of dynamic summarization may include reports for a support manager's review, a support agent's performance review, a support ticket's status evaluation, a customer account evaluation, a handoff between support agents, management or sharing with multiple support agents assigned to a support ticket, generation of support tickets related to a support ticket, and producing a summary from multiple summaries (meta summarization) potentially covering token-limits on public or proprietary Large Language Models (LLMs). The workflow also contains a feedback loop wherein the generated summaries are fed back into the model framework to refine predictions moving forward. The summaries may be generated as text initially but may be extended to include graphs and other analysis facets as well. A support organization can leverage “state-of-the-science” generative artificial intelligence models 426 to produce text summaries 434 of customers' support tickets and accounts for the support organization, so that such summaries will help the support organization to drive business value by making timely decisions on their customers' accounts with the end goal of customer retention and expansion.

The natural language processor machine-learning model 422 may provide an efficient user experience by enabling humans to communicate in the modes in which they are naturally most comfortable—that of conventional language. A consequence of the breadth and case with which humans communicate with one another in natural language is that inferring meaning from a support ticket's content may be challenging. Therefore, the natural language processor machine-learning model 422 relies on a multitude of advanced natural language processing techniques, some of which fall under the domain of machine-learning model techniques. When a support ticket or an account is summarized, the summary may include predictions made and/or metrics determined for the support ticket or the account. The primary input when making predictions about or determining metrics for a support ticket may be the content of the support ticket. Although the natural language processor machine-learning model 422 is oriented to mining information from text content, a well-performing voice-to-text application could render the natural language processor machine-learning model 422 as useful for voice calls as well.

The natural language processor machine-learning model 422 can infer tags, labels, or classifiers that may be used to summarize and/or describe the content of input language. This natural language processor machine-learning model 422 may be described as an attentional machine-learning model to learn not just the weights of the input words and phrases in how they pertain to a support ticket, but also which words and phrases are most relevant to predictions about or metrics for a support ticket given the structure of the input words and phrases. The qualifier “attentional” derives from the notion that this technique is, broadly speaking, similar to the manner in which humans choose what to pay attention to when focusing on a task. A customer who is experiencing a catastrophic computer system failure may give far greater weight to the computer system than to the clouds in the sky outside or the carpet in the room. Similarly, an attentional model can give far greater weight to the input that it deems most relevant to the task at the expense of other inputs.

This attentional model technique may represent a stark contrast to bag of words models in which all weights for an input have equal importance, and which discards the structure of the input. A bag of words model may be a natural language processing technique used for classifying natural language text, such as assigning a classification of positive or negative to a movie review based on the positive and negative words in the review's natural language text. Bag of words models may be trained to learn tokens, which are particular words or small phrases, and learn weights for the tokens, which are associated with classes or classifiers.

Continuing with the movie review example, since the token bad is in more negative reviews than positive reviews, a bag of words model learns a negative weight for the token bad. Although bag of words models may be reasonably accurate when classifying long documents, these models produce noisy results for small input sizes, such as sentence-or phrase-level texts, because of the small number of tokens available for weighting. Even classifying long documents may be problematic when dealing with technical support communications which often includes both human-generated natural language text and machine-generated text which is not in a natural language.

Attentional predictions may be made using a combination of general language models used to infer the syntax (structure and/or organization) of input language and task-specific models used to provide weight to language within the inferred structure. There may be several key outcomes of inferring the syntax of language in order to make predictions, in particular determining the role, such as parts of speech, of individual words, as well as the relationship of words and phrases to one another. Using combinations of tagged parts of speech and word or phrasal relationships may enable advanced behaviors such as determining whether a word or phrase in particular is being negated, expressed in a conditional or hypothetical manner, or expressed in a specific tense or mood. These advanced behaviors may greatly increase the accuracy of text classification on short documents which cause great challenges for conventional methods.

The simplest way in which predictions may be influenced by syntactic features is the suppression of key phrases that are negated. Conceptually this negation is straightforward in the example, “This is not a high priority issue.” However, in practice the natural language processor machine-learning model 422 is reliant on general language models that can achieve high accuracy using a technique called dependency parsing, in which direct, binary relationships are established between words in a sentence.

For example, in the sentence “This is a small problem,” the word “small” is directly related to the word “problem,” the word “This” is directly related to the word “is,” the word “is” is directly related to the word “a,” and the word “a” is directly related to the word “small” and indirectly to the word “problem.” The dependency chain may be followed to conclude that the word “This” is also indirectly related to the word “problem.”

Applying the same technique to the more complex example, “This is not a small problem, it is a disaster,” determines that the word “it” is indirectly related to the word “disaster,” the word “not” is indirectly related to the word “problem,” and very importantly that the word “not” is not related to the word “disaster.” This attentional model technique may provide much more accurate information as to the content of this text than a technique that would simply detect the presence of negative tokens such as “not” and negate any and all predictions pertaining to that text. Returning to the support context, this same attentional model technique can excel where other models do not, such as in the following example “This is a high priority issue and your response is not helpful.”

Modifying predictions of classifiers for words or phrases that occur within a conditional or hypothetical context may be crucial for suppressing would-be problems or outcomes that people naturally and frequently express. For example, technical support customers frequently express concern about problems that may not have actually happened, such as, “If this system had gone down, we would have had a major catastrophe on our hands.” Since the customer narrowly avoided a major catastrophe, and if the keyword extraction was being used to assign the corresponding support ticket to a support agent, then the support ticket may be assigned to a support agent with experience in resolving support tickets in a far less urgent manner than a support ticket from a customer who was in the midst of an ongoing catastrophe.

In such situations, using language-aware techniques may enable the natural language processor machine-learning model 422 to suppress language of this type from being surfaced up to or even being sent directly to an inbox of a support organization's upper management. The language-aware techniques may result in increased accuracy of the natural language processor machine-learning model 422, and greater confidence by support organizations that the artificial intelligence platform 400 assigns a support agent with sufficient experience to a support ticket. In contrast, a bag of words approach that searches for conditional terms such as would, could, and should, can only identify a small portion of expressions of the subjunctive mood and would unnecessarily suppress predictions when a conditional term is unrelated to the key aspects of the language being evaluated, such as “We have a major catastrophe on our hands-we would appreciate a response immediately!”

The server 312 can integrate a feedback loop, which may capture information from a user interface or an interaction layer and incorporate the captured information as inputs to the artificial intelligence models 420-426. The information captured is in essence the support organization management team's follow-up behavior on the predictions, metrics, and summaries as displayed via the user interface. For example, the management team may revise a summary for a variety of reasons.

Sweeping in these follow-up actions back into the artificial intelligence models 420-426 can enable the artificial intelligence models 420-426 to be re-trained in a manner that closely follows the human-decision making component, which the artificial intelligence models 420-426 attempt to model. This feedback loop can enable the artificial intelligence models 420-426 to evolve in a personalized manner with respect to the preferences of the management team, in a way that is relevant to the team. This can enable the system 300 to refine the artificial intelligence models 420-426 over time as additional data are gathered from user interfaces about factors that may impact the predictions, metrics, and summaries beyond the immediate customer-support agent interactions in a ticketing system's support ticket itself.

When required, the artificial intelligence models 420-426 may be retrained to remain up to date and capture all the variations in incoming data. In addition, the system 300 can bootstrap the training of the artificial intelligence models 420-426. Since the artificial intelligence models 420-426 demonstrate portability, they may be deployed for support organizations that may be newer and have not yet gathered enough historical data to train their customized models.

The artificial intelligence platform 316 may be deployed and leveraged in a variety of different ways. The artificial intelligence platform 316 can provide recommendations for support agents to accept assignment of a given support ticket in a decentralized approach, where each support agent views a list of support ticket s they are best suited for in their own user interface, or the artificial intelligence platform 316 can directly assign support ticket s to support agents. The artificial intelligence platform 316 can provide an overview of all open support tickets for a customer account or all customer accounts. The artificial intelligence platform 316 may be deployed for tasks that use recommender systems, such as user-based filtering, and collaborative filtering.

There are a variety of key benefits associated with deploying the artificial intelligence platform 316. From a customer point of view, support ticket resolution times may be faster, escalations can reduce, sentiment scores can increase, needs attention scores may be lower, customer engagement may be higher, and some direct form of end-user rating may be higher, such as higher customer satisfaction scores. From a support organization's point of view, costs associated with escalations may be reduced, customer disengagement and churn may be reduced, costs associated with sudden collaborations/resource allocation required may be saved when support tickets stop making progress (via Pods, mentoring queue, expert queue), knowledge transfer may be facilitated (surfaces paths to support ticket resolution for similar support tickets; surfaces experts), a robust system to improve support agent skills over time may be provided, overall support efficacy may be improved, support agents may be retained for longer terms; and burnout may be prevented.

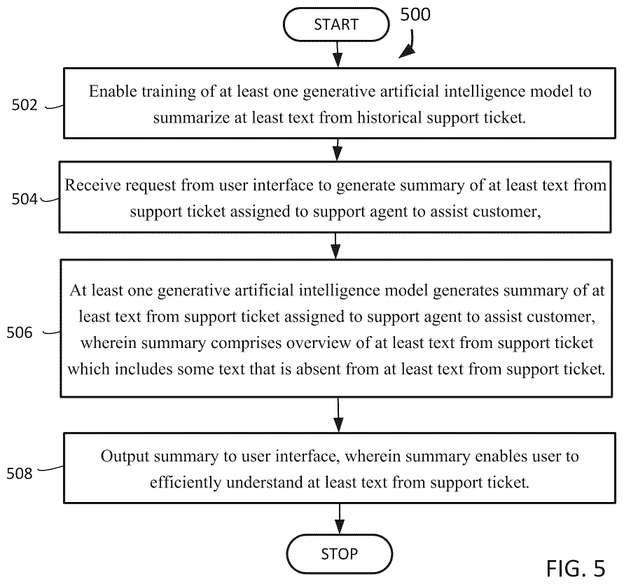

FIG. 5 is a flowchart that illustrates a computer-implemented method for generative artificial intelligence that dynamically summarizes text including support tickets, under an embodiment. Flowchart 500 depicts method acts illustrated as flowchart blocks for certain actions involved in and/or between the system elements 302-316 of FIG. 3.

At least one generative artificial intelligence model is fine-tuned to summarize at least text from a historical support ticket, block 502. The system receives closed support tickets which generative artificial intelligence models use to train to summarize the tickets' text. For example, and without limitation, this can include the server 312 receiving closed customer support tickets, which includes the support ticket 100 that contains subsequent communications 102 and 104 between a support agent and a customer, and the support ticket's metadata 106, as depicted by FIG. 1. Then the generative artificial intelligence models 426 were fine-tuned to summarize the text of the closed customer support tickets, including an overview which described the support ticket 100 as a “simple” remote mount problem with an “easy” solution, even though the words “simple” and “easy” were not in the support ticket 100, the subsequent communications 102 and 104, or the support ticket's metadata 106. This example describes fine-tuning a generative artificial intelligence model in a manner that is similar, on a much smaller scale, to the traditional training of machine-learning models.

A generative artificial intelligence model can be methods and software that enable machines to perceive their environment and uses learning to take actions that maximize their chances of achieving defined goals of creating new content. Text can be written or printed work, regarded in terms of its content rather than its physical form. A historical support ticket can be a request that was logged on a work tracking system detailing a problem that needed to be addressed.

A textual communication can be a written conveying of information or news. An audio communication can be a conveying by sound of information or news. An inbound comment can be a written or spoken remark by a customer expressing an opinion or reaction. An outbound comment can be a written or spoken remark to a customer who expresses an opinion or reaction by a support agent. An internal note can be a brief record within an organization of facts, topics, or thoughts. A metadata field can be an area of information about a support ticket which is extracted from the support ticket.

Following the fine-tuning of at least one generative artificial intelligence model to summarize at least text from a historical support ticket, a request is received from a user interface to generate a summary of at least text from a support ticket assigned to a support agent to assist a customer, block 504. The system receives a user's request to summarize text, which includes a support ticket. By way of example and without limitation, this can include the server 312 receiving support tickets, which include the support ticket 200 that contains the subsequent communication 202 and the support ticket's metadata 204, as depicted by FIG. 2, and then receiving a request from Sam, a system administrator, to generate a summary of a customer account for Acme Corporation, which includes the support ticket 200.

A request can be an instruction to a computer to provide information or perform another function. A user interface can be the means by which a person and a computer system interact, in particular the input devices and software. A summary can be a brief statement or account of the main points of something. A support ticket can be a request logged on a work tracking system detailing a problem that needs to be addressed. A support agent can be a person who is responsible for providing an act of assistance. A customer can be a person or organization that buys goods and/or services from a business.

The request to generate a summary may be based on text associated with at least one of the following: at least one other support ticket, at least one support agent, at least one customer, at least one topic of the support ticket, and/or at least one point in time. For example, Sam requests a summary of the Acme Corporation's support tickets which involved remote mount problems during the last year and which were handled by either of the support agents Al or Ann. A topic can be a subject matter dealt with in a support ticket. A point in time can be a particular moment.

The at least the text from the support ticket may also include at least one of a question, a message, a comment, a note, an email, a chat message, a knowledge-based article, another support ticket, or a customer satisfaction survey. For example, Sam the system administrator requested the summary of the Acme Corporation's support tickets which involved remote mount problems to also summarize the user manual's sections that were provided to Acme and which describe solutions for remote mount problems.

A question can be a sentence worded or expressed so as to elicit information. A message can be a written or recorded communication sent to or left for a recipient. A support ticket comment can be a written or spoken remark which expresses an opinion or reaction by a support agent. A support ticket note can be a brief record which is from outside an organization and which provides facts, topics, or thoughts. An email can be a message distributed by electronic means from one computer user to one or more recipients via a network. A chat message can be a real-time, one-on-one assistance between customers and a support agent on a company's website or application. A knowledge-based article can be a piece of writing which conveys facts and information and which is included with other writings in a publication. A customer satisfaction survey can be questionnaire regarding the contentment by a person or organization that buys goods and/or services from a business.

Having received a request from a user interface to generate a summary of at least text from a support ticket assigned to a support agent to assist a customer, at least one generative artificial intelligence model generates a summary of the at least text from the support ticket, wherein the summary comprises an overview of the at least the text from the support ticket which includes some text that is absent from the at least the text from the support ticket, block 506. The system's generative artificial intelligence models generate summaries of text from support tickets. In embodiments, this can include the generative artificial intelligence models 426 summarizing the text of the customer Acme Corp's support tickets, including an overview which described the support ticket 200 as a “difficult” remote mount problem with a “complex” solution, even though the words “difficult” and “complex” are not in the support ticket 200, the subsequent communication 202, or the support ticket's metadata 204. An overview can be a general outline or summary of a subject.

Generating the summary may be based on at least one of a feature, a communication, a descriptive statistic, or a metric derived by machine-learning, which is associated with the support ticket. For example, the generative artificial intelligence models 426 use a feature of the support ticket, which is the external source of content in the user manual provided to Acme, which describes solutions to remote mount problems, to describe the remote mount problem for the support ticket 200 as a “complex” problem. Similarly, the generative artificial intelligence models 426 use a descriptive statistic, which is the lengthy wait until the first response by the support agent Ann occurred, to describe the remote mount problem as a “difficult problem.”

A feature can be a distinctive attribute or aspect of something. A communication can be the imparting of information. A descriptive statistic can be an illustrative fact or piece of data from a study of a large quantity of numerical data. A metric derived by machine-learning can be a standard of measurement calculated by artificial intelligence. A support ticket feature may be at least one of a status, a priority, a customer contact, or a customer account. A communication can be at least one of an inbound message, an outbound message, an internal comment, an external comment, an email, a voice recording, a voice transcription, a video recording, a transcript, or an external source of content. For example, the generative artificial intelligence models 426 uses the user manual provided to Acme, which describes solutions to remote mount problems, to describe the remote mount problem for the support ticket 200 as a “complex” problem because the user manual does not list the specific problem described in the support ticket 200, much less a solution.

A status can be a condition, state of matters or stage progress. A priority can be a condition of being regarded or treated as more important. A customer contact can be a person through whom one can gain access to information from an organization that buys goods and/or services from a business. A customer account can be a record or statement of financial expenditures and receipts relating to a person or an organization that buys goods and/or services from a business. An internal comment can be a written or spoken remark within an organization expressing an opinion or reaction.

An external comment can be a written or spoken remark outside an organization expressing an opinion or reaction. A voice recording can be sound information captured by a storage medium. A voice transcription can be sound information converted to a written format. A video-recording can be moving visual images captured on a storage medium. A transcript can be a written or printed version of material originally presented in another medium. An external source of content can be a provider of text that originates outside the system that summarizes the text.

A descriptive statistic may be at least one of an age, a first response time of a support agent, a ratio between inbound comments and outbound comments, a resolution rate for support tickets, a total number of support agents assigned to a support ticket, a mean-time associated with one of a resolution time for support tickets, or a response by one of a customer or a support, and/or a level associated with one of a priority, a severity, or an urgency. A metric derived by machine-learning may be at least one of a probability associated with one of a customer call, an escalation, a churn risk, or a customer sentiment, and/or a score associated with one of a customer effort, a customer satisfaction, a needs attention, or a net promoter. agent. For example, the generative artificial intelligence models 426 uses the lengthy wait until the first response by the support agent Ann occurred, which contrasts with Ann's typically quick responses, to describe the remote mount problem listed in the support ticket 200 as “difficult” because Ann only takes a long time to respond to support tickets when the support ticket is for a difficult problem.

An age can be the length of time that a thing has existed. A first response time can be a chronological measure of a duration until an initial reply to a support ticket. A ratio can be the quantitative relation between two amounts. An inbound comment can be a written or spoken remark by a customer expressing an opinion or reaction. An outbound comment can be a written or spoken remark by a support agent expressing an opinion or reaction. A resolution rate can be a percentage of support tickets successfully closed. A total number can be an arithmetical value that represents a whole amount. A level can be a position on a real or imaginary scale of amount, quantity, extent, or quality.

A severity can be a condition of something that is bad or undesirable. An urgency can be a condition of being important and requiring swift action. A probability can be the likelihood of something happening or being the case. A customer call can be a phone communication by a person or organization that buys goods and/or services from a business. An escalation can be a demand for an increase in service for a support ticket. A churn risk can be a danger that a customer will end their relationship with a company within a given period. A customer sentiment can be an attitude toward a situation or event by a person or organization that buys goods and/or services from a business. A score can be a number that expresses accomplishment (as in a test) or excellence (as in quality) either absolutely in points gained or by comparison to a standard.

A customer effort can be energy expended by a person or organization that buys goods and/or services from a business. A customer satisfaction can be contentment by a person or organization that buys goods and/or services from a business. A needs attention can be a requirement for assistance. A net promoter can be a customer who recommends a company's products and/or services to potential customers. A mean-time can be a chronological measure required before some specific thing happens. A resolution time can be aa chronological measure that is required for resolving a support ticket. A response can be a written answer.

After at least one generative artificial intelligence model generates a summary of the at least text from the support ticket assigned to the support agent to assist the customer, the summary is output to the user interface, wherein the summary enables a user to efficiently understand the at least the text from the support ticket, block 508. The system outputs the summaries of text which include support tickets. For example, and without limitation, this can include the server 312 outputting the summary of Acme Corp.'s customer account to Sam the system administrator, who can efficiently understand the overview of the Acme's support tickets, including the summary of the support ticket 200. A user can be a person who operates a computer.

The summary may also be used for at least one of a management of multiple support agents assigned to a support ticket, a handoff between support agents, an evaluation of at least one of a customer account or a support ticket, and/or a generation of one of another support ticket related to the support ticket, of a summary of the summary and other summaries, or a performance review associated with at least one of a support agent or a support manager. For example, the summary enabled Sam the system administrator, to evaluate Acme's customer account as needing additional attention from support agents in the future and to also assign a subject matter expert in the field of remote mount problems to the support ticket 200 to prevent escalation of service and reduce the probability of customer churn.

A management can be the process of dealing with people. A hand-off can be a transfer of responsibility for a support ticket to another's possession. An evaluation can be an assessment or the making of a judgment about the amount, number, or worth of something. A generation can be the production of something. A performance review can be a formal assessment in which a supervisor evaluates an employee's work. A support manager can be a supervisor of a person who is responsible for providing an act of assistance.

The server 312 can convey the summaries to downstream applications and/or models, one of which provides a number of possible reasons for a customer's remote mount problem to support agents who have the related skills to assist with the software product problem and are eligible to be assigned the support ticket 200. In another example, the server 312 conveys the summary to downstream applications and/or models, one of which determines that a disproportionally large number of customers have initiated support tickets for assistance with remote mount problems, which implies that a specific software product may lack clear usage instructions, error messaging, and/or self-help guidance related to remote mount procedures. In yet another example, the server 312 conveys the summary to downstream applications and/or models, one of which determines that a disproportionally large number of support agents who have responded to support tickets to assist with problems related to remote mounts, need additional training to enable them to better assist customers who are experiencing problems with remote mounts.

Although FIG. 5 depicts the blocks 502-508 occurring in a specific order, the blocks 502-508 can occur in another order. In other implementations, each of the blocks 502-508 can also be executed in combination with other blocks and/or some blocks may be divided into a different set of blocks.

### System Overview

An exemplary hardware device in which the subject matter may be implemented shall be described. Those of ordinary skill in the art will appreciate that the elements illustrated in FIG. 6 can vary depending on the system implementation. With reference to FIG. 6, an exemplary system for implementing the subject matter disclosed herein includes a hardware device 600, including a processing unit 602, a memory 604, a storage 606, a data entry module 608, a display adapter 610, a communication interface 612, and a bus 614 that couples elements 604-612 to the processing unit 602.

The bus 614 can comprise any type of bus architecture. Examples include a memory bus, a peripheral bus, a local bus, etc. The processing unit 602 is an instruction execution machine, apparatus, or device and can comprise a microprocessor, a digital signal processor, a graphics processing unit, an application specific integrated circuit (ASIC), a field programmable gate array (FPGA), etc. The processing unit 602 may be configured to execute program instructions stored in the memory 604 and/or the storage 606 and/or received via the data entry module 608.

The memory 604 can include a read only memory (ROM) 616 and a random-access memory (RAM) 618. The memory 604 may be configured to store program instructions and data during operation of the hardware device 600. In various embodiments, the memory 604 can include any of a variety of memory technologies such as static random-access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example.

The memory 604 can also include nonvolatile memory technologies such as nonvolatile flash RAM (NVRAM) or ROM. In some embodiments, it is contemplated that the memory 604 can include a combination of technologies such as the foregoing, as well as other technologies not specifically mentioned. When the subject matter is implemented in a computer system, a basic input/output system (BIOS) 620, containing the basic routines that help to transfer information between elements within the computer system, such as during start-up, is stored in the ROM 616.

The storage 606 can include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 600.

It is noted that the methods described herein may be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like can also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high-definition DVD (HD-DVD™), a BLU-RAY disc; and the like.

A number of program modules may be stored on the storage 606, the ROM 616 or the RAM 618, including an operating system 622, one or more applications programs 624, program data 626, and other program modules 628. A user can enter commands and information into the hardware device 600 through data entry module 608. The data entry module 608 can include mechanisms such as a keyboard, a touch screen, a pointing device, etc. Other external input devices (not shown) are connected to the hardware device 600 via an external data entry interface 630.

By way of example and not limitation, external input devices can include a microphone, joystick, game pad, satellite dish, scanner, or the like. In some embodiments, external input devices can include video or audio input devices such as a video camera, a still camera, etc. The data entry module 608 may be configured to receive input from one or more users of the hardware device 600 and to deliver such input to the processing unit 602 and/or the memory 604 via the bus 614.

A display 632 is also connected to the bus 614 via the display adapter 610. The display 632 may be configured to display output of the hardware device 600 to one or more users. In some embodiments, a given device such as a touch screen, for example, can function as both the data entry module 608 and the display 632. External display devices can also be connected to the bus 614 via the external display interface 634. Other peripheral output devices, not shown, such as speakers and printers, may be connected to the hardware device 600.

The hardware device 600 can operate in a networked environment using logical connections to one or more remote nodes (not shown) via the communication interface 612. The remote node may be another computer, a server, a router, a peer device or other common network node, and typically includes many or all of the elements described above relative to the hardware device 600. The communication interface 612 can interface with a wireless network and/or a wired network.

Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, the communication interface 612 can include logic configured to support direct memory access (DMA) transfers between the memory 604 and other devices.

In a networked environment, program modules depicted relative to the hardware device 600, or portions thereof, may be stored in a remote storage device, such as, for example, on a server. It will be appreciated that other hardware and/or software to establish a communications link between the hardware device 600 and other devices may be used.\

It should be understood that the arrangement of the hardware device 600 illustrated in FIG. 6 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) may be realized, in whole or in part, by at least some of the components illustrated in the arrangement of the hardware device 600.

In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 6.

Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the descriptions above, the subject matter is described with reference to acts and symbolic representations of operations that are performed by one or more devices, unless indicated otherwise. As such, it is understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is described in a context, it is not meant to be limiting as those of skill in the art will appreciate that various of the acts and operations described hereinafter can also be implemented in hardware.

To facilitate an understanding of the subject matter described above, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for generative artificial intelligence that dynamically summarizes text including support tickets, the system comprising:
one or more processors; and
a non-transitory computer readable medium storing a plurality of instructions, which when executed, cause the one or more processors to:
fine-tune at least one generative artificial intelligence model to summarize at least text from a historical support ticket;
generate, by the at least one generative artificial intelligence model, a summary of at least text from a support ticket assigned to a support agent to assist a customer, wherein the summary comprises an overview of the at least the text from the support ticket and which includes some text that is absent from the at least the text from the support ticket, in response to receiving a request from a user interface to generate the summary; and
output the summary to the user interface, wherein the summary enables a user to efficiently understand the at least the text from the support ticket.

2. The system of claim 1, wherein the request to generate the summary is based on text associated with at least one of the following: at least one other support ticket, at least one support agent, at least one customer, at least one topic of the support ticket, and at least one point in time.

3. The system of claim 1, wherein the at least the text from the support ticket further comprises at least one of a question, a message, a support ticket comment, a support ticket note, an email, a chat message, a knowledge-based article, another support ticket, or a customer satisfaction survey.

4. The system of claim 1, wherein generating the summary is based on at least one of features, communications, descriptive statistics, or metrics derived by machine-learning, associated with the support ticket.

5. The system of claim 4, wherein the features of the support ticket comprise at least one of a status, a priority, a customer contact, or a customer account, and a communication comprises at least one of an inbound message, an outbound message, an internal comment, an external comment, an email, a voice recording, a voice transcription, a video recording, a transcript, or an external source of content.

6. The system of claim 4, wherein the descriptive statistic comprises at least one of an age, a first response time of a support agent, a ratio between inbound comments and outbound comments, a resolution rate for support tickets, a total number of support agents assigned to a support ticket, a level associated with one of a priority, a severity, or an urgency, or a mean-time associated with one of a resolution time for support tickets, or a response by one of a customer or a support agent, and a metric derived by machine-learning comprises at least one of a probability associated with one of a customer call, an escalation, a churn risk, or a customer sentiment, a score associated with one of a customer effort, a customer satisfaction, a needs attention, or a net promoter.

7. The system of claim 1, wherein the summary is also used for at least one of a management of multiple support agents assigned to a support ticket, a hand-off between support agents, an evaluation of at least one of a customer account or a support ticket, a generation of one of another support ticket related to the support ticket, or of a summary of the summary and other summaries, or a performance review associated with at least one of a support agent or a support manager.

8. A computer-implemented method for generative artificial intelligence that dynamically summarizes text including support tickets, the computer-implemented method comprising:
fine-tuning of at least one generative artificial intelligence model to summarize at least text from a historical support ticket;
generating by the at least one generative artificial intelligence model, a summary of at least text from a support ticket assigned to a support agent to assist a customer, wherein the summary comprises an overview of the at least the text from the support ticket and which includes some text that is absent from the at least the text from the support ticket, in response to receiving a request from a user interface to generate the summary; and
outputting the summary to the user interface, wherein the summary enables a user to efficiently understand the at least the text from the support ticket.

9. The computer-implemented method of claim 8, wherein the request to generate the summary is based on text associated with at least one of the following: at least one other support ticket, at least one support agent, at least one customer, at least one topic of the support ticket, and at least one point in time.

10. The computer-implemented method of claim 8, wherein the at least the text from the support ticket further comprises at least one of a question, a message, a support ticket comment, a support ticket note, an email, a chat message, a knowledge-based article, another support ticket, or a customer satisfaction survey.

11. The computer-implemented method of claim 8, wherein generating the summary is based on at least one of features, communications, descriptive statistics, or metrics derived by machine-learning, associated with the support ticket.

12. The computer-implemented method of claim 11, wherein the features of the support ticket comprise at least one of a status, a priority, a customer contact, or a customer account, and a communication comprise at least one of an inbound message, an outbound message, an internal comment, an external comment, an email, a voice recording, a voice transcription, a video recording, a transcript, or an external source of content.

13. The computer-implemented method of claim 11, wherein the descriptive statistic comprises at least one of an age, a first response time of a support agent, a ratio between inbound comments and outbound comments, a resolution rate for support tickets, a total number of support agents assigned to a support ticket, a level associated with one of a priority, a severity, or an urgency, or a mean-time associated with one of a resolution time for support tickets, or a response by one of a customer or a support agent, and a metric derived by machine-learning comprises at least one of a probability associated with one of a customer call, an escalation, a churn risk, or a customer sentiment, a score associated with one of a customer effort, a customer satisfaction, a needs attention, or a net promoter.

14. The computer-implemented method of claim 8, wherein the summary is also used for at least one of a management of multiple support agents assigned to a support ticket, a hand-off between support agents, an evaluation of at least one of a customer account or a support ticket, a generation of one of another support ticket related to the support ticket, or of a summary of the summary and other summaries, or a performance review associated with at least one of a support agent or a support manager.

15. A computer program product, comprising a non-transitory computer-readable medium having a computer-readable program code embodied therein to be executed by one or more processors, the program code including instructions to:
fine-tune at least one generative artificial intelligence model to summarize at least text from a historical support ticket;
generate, by the at least one generative artificial intelligence model, a summary of at least text from a support ticket assigned to a support agent to assist a customer, wherein the summary comprises an overview of the at least the text from the support ticket and which includes some text that is absent from the at least the text from the support ticket, in response to receiving a request from a user interface to generate the summary; and
output the summary to the user interface, wherein the summary enables a user to efficiently understand the at least the text from the support ticket.

16. The computer program product of claim 15, wherein the request to generate the summary is based on text associated with at least one of the following: at least one other support ticket, at least one support agent, at least one customer, at least one topic of the support ticket and at least one point in time.

17. The computer program product of claim 15, wherein the at least the text from the support ticket further comprises at least one of a question, a message, a support ticket comment, a support ticket note, an email, a chat message, a knowledge-based article, another support ticket, or a customer satisfaction survey.

18. The computer program product of claim 15, wherein generating the summary is based on at least one of features, communications, descriptive statistics, or metrics derived by machine-learning, associated with the support ticket, and the features of the support ticket comprise at least one of a status, a priority, a customer contact, or a customer account, and a communication comprises at least one of an inbound message, an outbound message, an internal comment, an external comment, an email, a voice recording, a voice transcription, a video recording, a transcript, or an external source of content.

19. The computer program product of claim 18, wherein the descriptive statistic comprises at least one of an age, a first response time of a support agent, a ratio between inbound comments and outbound comments, a resolution rate for support tickets, a total number of support agents assigned to a support ticket, a level associated with one of a priority, a severity, or an urgency, or a mean-time associated with one of a resolution time for support tickets, or a response by one of a customer or a support agent, and a metric derived by machine-learning comprises at least one of a probability a probability associated with one of a customer call, an escalation, a churn risk, or a customer sentiment, or a score associated with one of a customer effort, a customer satisfaction, a needs attention, or a net promoter.

20. The computer program product of claim 15, wherein the summary is also used for at least one of a management of multiple support agents assigned to a support ticket, a hand-off between support agents, an evaluation of at least one of a customer account or a support ticket, a generation of one of another support ticket related to the support ticket, or of a summary of the summary and other summaries, or a performance review associated with at least one of a support agent or a support manager.
